(19) United States
(12) Patent Application Publication
(10) Pub. No.: US 2002/0070175 A1
(43) Pub. Date: Jun. 13, 2002

(54) Systems and methods for gas exchange and/or organic separation from fluids

(76) Inventors: Neil E. Helwig, Mason, OH (US); Thomas Lauttenbach, Newton, NH (US); Edward D. Aneshansley, Ipswich, MA (US)

Correspondence Address: FOLEY, HOAG & ELIOT, LLP, PATENT GROUP, ONE POST OFFICE SQUARE, BOSTON, MA, 02109, US

(21) Appl. No.: 09/934,418

(22) Filed: Aug. 21, 2001

Related U.S. Application Data
(60) Provisional application No. 60/231,665, filed on Sep. 11, 2000.

(51) Int. Cl. C02F 1/24

(52) U.S. Cl. 210/703; 210/758; 210/221.2

(57) ABSTRACT

An apparatus for facilitating the separation of organic materials from a fluid and for promoting the gas exchange from the fluid is provided. The apparatus includes a column having an interior chamber extending between a first end and a second end of the column. A plenum is situated circumferentially about the second end of the column. At a junction between the plenum and the interior chamber, an annulus is provided to permit the plenum to be in fluid communication with the interior chamber. An external port is provided for communication with the plenum. A column of media may be provided in the interior chamber through which fluid to be treated may flow.

### RELATED U.S. APPLICATION(S)

The present application claims priority to U.S. Patent Application Serial No. 60/231,665, filed Sep. 11, 2000, which application is hereby incorporated herein by reference.

### FIELD OF THE INVENTION

The present invention relates to systems and methods for facilitating the separation of organics from fluids and/or the exchange of gases within fluids.

### BACKGROUND ART

Protein removing devices have been used to remove dissolved proteins and/or other dissolved organic compounds from, for example, aquaculture fluid. These devices typically introduce a fluid to be treated through a top portion of a reactor vessel, and a countercurrent of air through a mechanism that creates small or fine bubbles near the bottom portion of the reactor vessel. As the bubbles rise up the reactor vessel through the fluid to be treated, proteins and/or other organics adhere/adsorb to the bubbles and float to the surface level to the fluid in the vessel. The accumulation of the bubbles having the proteins and/or other organics adhering/adsorbing thereto at the surface of the fluid in the vessel generates foam. The foam can subsequently be removed to remove the proteins and/or other organics from the vessel.

### SUMMARY OF THE INVENTION

The present invention provides, in one embodiment, an apparatus for facilitating the separation of material dissolved from a fluid to be treated. The apparatus, in accordance with an embodiment, includes a column having an interior chamber extending between a first end and a second end of the column. The apparatus further includes a plenum situated circumferentially about the second end of the column and having a lower end. At a junction between the plenum and the interior chamber, an annulus is provided, so as to permit the plenum to be in fluid communication with the interior chamber of the column. The apparatus is further provided with an external port in communication with the plenum. In an embodiment, a packed column of media is placed within the interior chamber, such that a spatial gap is defined between an end of the column of media closest to the annulus and the lower end of the plenum. The apparatus may also include an inlet positioned at the first end of the column and through which fluid to be treated may be introduced on to the packed column of media.

The present invention also provides a method for facilitating the separation of material, dissolved in a fluid to be treated, from the fluid. The method includes providing the apparatus discussed above. Thereafter, fluid to be treated may be introduced through the inlet and on to the column of media. As fluid is introduced through the inlet, air may be introduced into the column such that it comes into contact with the fluid. Next, the fluid is allowed to descend through the column of media in a manner which generates bubbles. Subsequently the material dissolved in the fluid may be permitted to separate from the fluid and adhere/adsorb to the bubbles. The treated fluid, now substantially free of the dissolved material, may be collected at the second end of the column. As for the bubbles, as it exits the column of media, the bubbles may be permitted to coalesce into foam on the surface of the collected treated fluid and within the spatial gap. Thereafter, the coalesced foam in the spatial gap may be directed through the annulus and into the plenum. Once the foam is within the plenum, the foam may be removed through the external port.

The present invention further provides, in one embodiment, a method for facilitating gas exchange in a fluid to be treated. The fluid to be treated, having a first content of a gas to be exchanged dissolved therein, may be uniformly distributed on to a column of media and permitted to flow therethrough. As the fluid descends through the column of media, a second fluid (e.g., a gas), having a second content of the gas to be exchanged, may be introduced into the column of media in a countercurrent or co-current manner to the flow of the fluid to be treated. Thereafter, as the fluid to be treated interacts with the second fluid, a diffusion process is permitted to occur between the fluid to be treated and the second fluid, such that the gas content in each of the fluids is altered. This process may be used to remove a particular gas from a fluid to be treated or to infuse a particular gas into the fluid to be treated, depending on the initial content of the gas to be exchanged in the fluid to be treated. Thus, if the fluid to be treated is initially deficient of the gas to be exchanged, the introduction of a second fluid that is rich in the gas to be exchanged will allow an infusion of the gas from the second fluid to the fluid to be treated. Likewise, if the fluid to be treated is initially rich in a gas to be exchanged, the introduction of a second fluid that is deficient in the gas to be exchanged will allow for a removal of the gas from the treated fluid to the second fluid.

The present invention further provides, in another embodiment, the removal of organic materials from a fluid to be treated concurrently with the exchange of gas from the fluid to be treated to a second fluid.

### BRIEF DESCRIPTION OF THE DRAWINGS

FIG. 1 illustrates, in accordance with an embodiment of the present invention, an apparatus for facilitating the separation of material dissolved in a fluid.

FIG. 2 illustrates, in another embodiment, an apparatus for facilitating the separation of material dissolved in a fluid.

### DESCRIPTION OF VARIOUS EMBODIMENTS

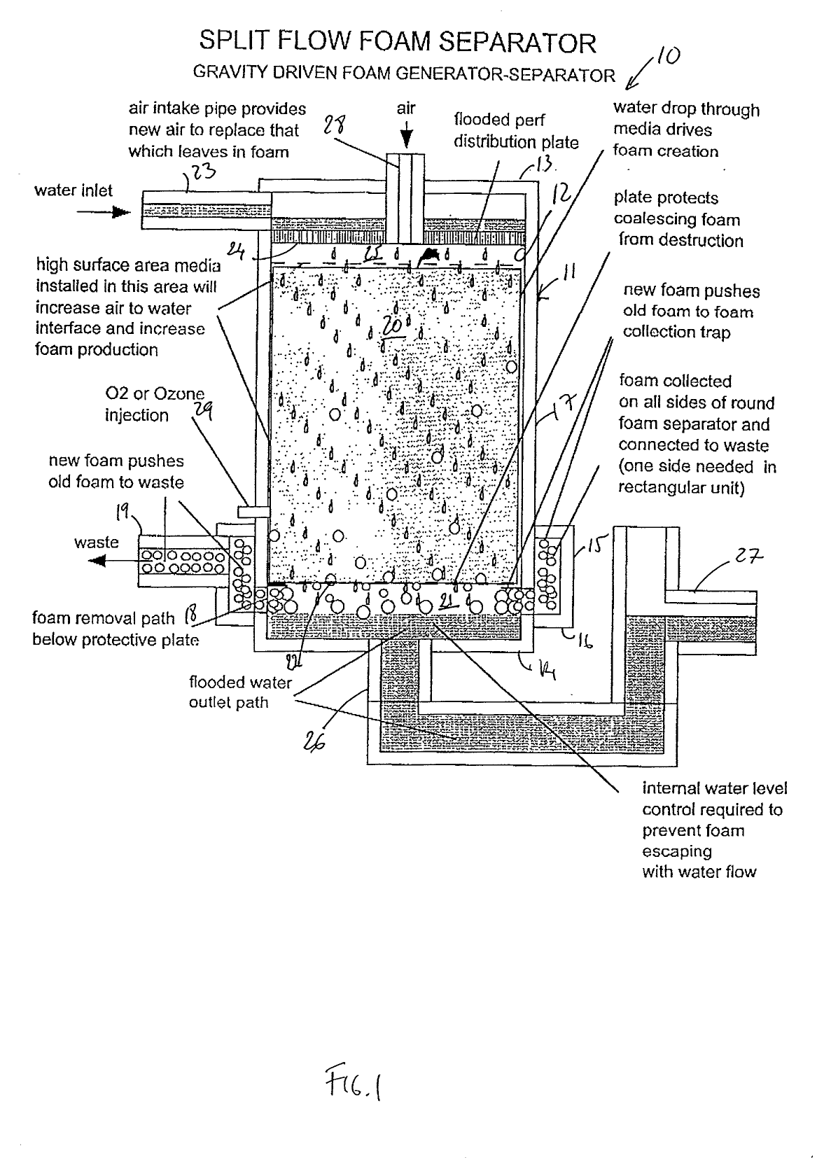

Referring now to the drawings, FIG. 1 illustrates, in accordance with an embodiment, an apparatus 10 for facilitating separation of material dissolved in a fluid to be treated. The apparatus 10 includes a column 11 having an interior chamber 12 extending between a first end 13 and a second end 14 of the column. The column 11, in accordance with one embodiment, may be substantially cylindrical in shape along its entire length. Although shown to be substantially cylindrical, it should be appreciated that the column 11 may be provided with any geometrical shape along its length, so long as the shape permits the column to maintain fluid to be treated therein.

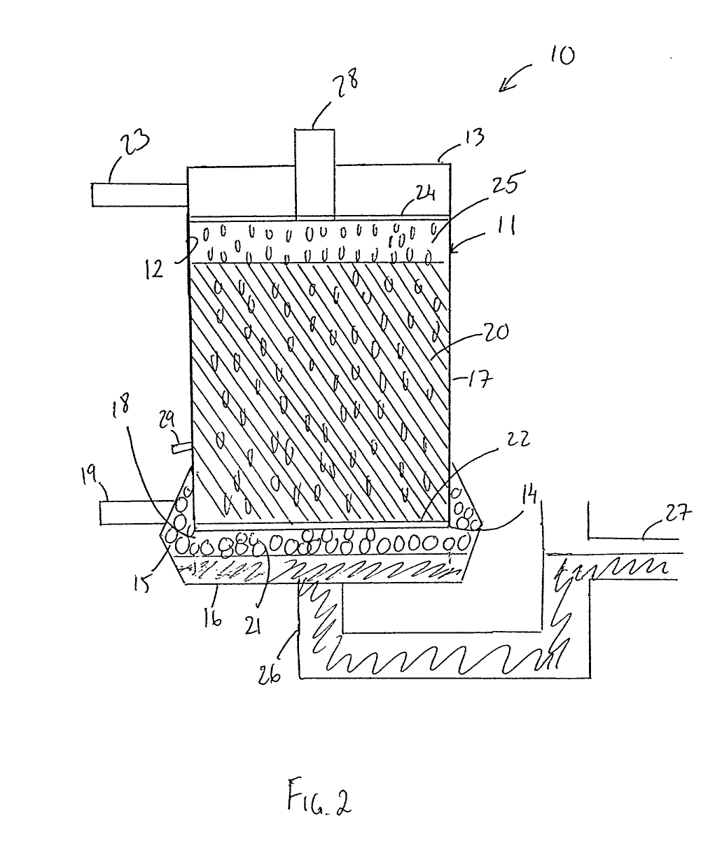

The apparatus 10 further includes a plenum 15 situated circumferentially about the second end 14 of the column 11, and includes a lower end 16. As shown in FIG. 1, plenum 15 may be situated circumferentially about an outer surface 17 of the column 11. In such an embodiment, it should be appreciated that the lower end 16 of the plenum 15 sits substantially above the second end 14 of the column 11. Alternatively, as illustrated in FIG. 2, the lower end 16 of the plenum 15 may encompass the second end 14 of column 11. The plenum 15, in either of the embodiments, may be designed to have any geometrical shape.

At a junction between the plenum 15 and the interior chamber 12, an annulus 18 may be provided, so as to permit the plenum 15 to be in fluid communication with the interior chamber 12 of the column 11. Further, an external port 19 may be provided in communication with the plenum 15.

In one embodiment, a packed column of media 20 may be placed within the interior chamber 12, such that a spatial gap 21 may be defined between an end 22 of the column of media 20 closest to the annulus 18 and the lower end 16 of the plenum 15. The column of media 20, in a preferred embodiment, includes a plurality of materials having substantially high specific surface area. The high surface area materials may also include a high number of voids. Such materials may be plastic packing, structured packing, beads, balls, or similar packing materials may be used. By providing the media 20 with such materials, fluid flowing through the media 20 and across the surfaces of the materials may be broken up, thereby resulting in an enhanced increase in the air to fluid interface. Such an increase may facilitate the separation of dissolved organic materials from the fluid to be treated. The column of media 20, in one embodiment, may be positioned on a perforated support plate 22 placed across the interior chamber 12 of the column 11. The perforated support plate 22, as shown in FIG. 1, may be positioned immediately above the annulus 18. The support plate 22 may be placed in a manner which does not result in the interference of fluid (e.g., liquid, air, gas, or foam) moving to or from the plenum 15.

The apparatus 10 may also include an inlet 23 positioned at the first end 13 of the column 11. The inlet 23 provides a path through which fluid to be treated may be introduced on to the packed column of media 20. In one embodiment, a perforated distribution plate 24 may be placed within the interior chamber 12 above the packed column of media 20. Placement of the distribution plate 24 in the manner illustrated in FIG. 1 creates a second spatial gap 25 between the distribution plate 24 and the top surface of the column of media 20. The perforation (not shown) on the distribution plate 24 may be sufficiently spaced from one another and may be of a diameter, which permits fluid from the inlet 23 to be evenly accumulate on the distribution plate 24, while permitting the fluid to be uniformly distributed (e.g., dripping across the gap 25) on to the packed column of media 20. Alternatively, the inlet 23 may include a device similar to a spray nozzle (not shown) placed immediately above the column of media 20, or any similar devices that permits substantially even distribution of the fluid on to the packed column of media 20. In the event that such a device is used in connection with inlet 23, distribution plate 24 may not be necessary.

The treated fluid, once descended the column of media 20, across the perforated support plate 22 and into the spatial gap 21, may be collected at the second end 14 of the column 11. In the embodiment shown in FIG. 2, the treated fluid may be collected at the lower end 16 of the plenum 15. An outlet 26 may be provided in communication with the second end 14 of the column 11, such that the collected treated fluid may exit from the apparatus 10. It should be appreciated that the outlet 26 may be provided with a controller, such as an internal water level control 27 shown in FIG. 1, to regulate the outflow of treated fluid from the apparatus 10, so that an amount of treated fluid may be permitted to remain within the column 11. In one embodiment of the invention, the amount of treated fluid remaining may be used to define the height of the spatial gap 21, so as to optimize the ability to collect the dissolved material that has been separated from the treated fluid. Although the FIG. 1 illustrates one controller 27 for use in connection with the apparatus 10 of the invention, other controllers may also be used to regulate the outflow of treated fluid, for instance a valve.

In operation, the apparatus 10 of the present invention may have various applications, including being used as an organic separator, a CO₂ stripper, an oxygenator, or for other gas/fluid (e.g., nitrogen, argon, sulfur etc.) exchange processes.

In operation as an organic separator, whereby the apparatus 10 may be used to separate dissolved organic materials from the fluid to be treated, the fluid to be treated may first be introduced through the inlet 23 and on to the column of media 20. In an embodiment, the fluid to be treated, such as water from an aquaculture environment, may be uniformly and evenly distributed across the packed column of media 20 by permitting the fluid to accumulate on perforated distribution plate 24, and subsequently allowed to substantially uniformly distribute on to the column of media 20. As fluid is introduced through the inlet 23, in one embodiment, air from, for instance, the atmosphere, may be introduced into the column 11, by way of, for example, intake pipe 28, such that it comes into contact with the fluid to be treated. Although intake pipe 28 may be used, such an intake pipe may not be necessary. In particular, column 11 may be designed such that the top end 13, rather than be enclosed, such as that shown in FIG. 1, would be open to the atmosphere.

After moving across the perforated plate 24, the fluid to be treated is allowed to descend, in one embodiment, across the gap 25 and through the column of media 20. It should be noted that as the fluid to be treated flows across perforated plate 24, the fluid tends to generate a slight negative pressure environment within the second spatial gap 25 relative to the environment outside of the pipe 28. As such, atmospheric air may be pulled into the column 11 through pipe 28. If desired, the fluid may be permitted to drip directly on to the column of media 20 without traversing the gap 25. As fluid travels through the column of media 20, the fluid may be broken up by the high surface area media 20 to increase the air to water interface. As a result of such action, foam may be generated within the column of media 20. The presence of a high surface area media, and atmospheric air within the column of media 20 enhances the generation of bubbles, which it is believed, allow the organic materials dissolved in the fluid to adhere/adsorb to the surface of bubbles, thereby separating the organic materials from the treated fluid. The bubbles with the adhered organic materials can subsequently coalesce into a foam. The generation of foam may be enhanced, in one embodiment, by providing gaseous injections, or other similar fluids, into the column of media 20. Specifically, an injection port 29 may be provided so that oxygen (O₂), ozone (O₃), or ozone-enriched oxygen may be introduced as a countercurrent directly into the treated fluid flowing through the column of media 20. The injection port 29 may be a single inlet, as shown in FIG. 1, or may be multiple inlets. If desired, the injection port 29 may include a plenum design with an annulus similar to that described above in connection with the external port 19. The use of oxygen or ozone-enriched oxygen can facilitate the break down of organic materials in the treated fluid, thus promoting adherence/adsorption of the organic materials to the bubbles in the foam.

The fluid, having been treated and now substantially free of the organic material, may continue its course through the column of media 20 and may be collected at the second end 14 of the column 11. In the embodiment shown in FIG. 2, the treated fluid may be collected at the lower end 16 of plenum 15. As for the foam having the organic materials adhering/adsorbing thereto, as it exits from the column of media 20 and through the support plate 22, the foam may be permitted to coalesce on the surface of the collected treated fluid and within the spatial gap 21. Thereafter, the coalesced foam in the spatial gap 21 may be directed through the annulus 18 and into the plenum 15. In particular, as additional foam exits through the column of media 20, existing coalesced foam within the spatial gap 21 gets pushed through the annulus 18, into the plenum 15, and through external port 19.

In order to optimize the amount of foam directed into the plenum 15, it should be appreciated that the gap 21 must be of a sufficient height to enhance the coalescence of the foam, while minimizing the destruction of the coalesced foam by treated fluid exiting the column of media 20. The height of the spatial gap 21 may be adjusted, in one embodiment, by adjusting the level of treated fluid collected at the second end 14 of the column 11. The level of fluid collected at the second end 14 may be adjusted by controller 27.

Once the foam is within the plenum 15, the foam may be removed through the external port 19. Although only one port 19 is shown, it should be noted that a plurality of ports 19 may be used to expedite the removal of the foam, if necessary. As the foam having trapped air therein is removed, additional air from the atmosphere may be pulled into the column 11 through the pipe 28 to replace the removed air. The presence of atmospheric air, again, can facilitate the generation of bubbles, and subsequently foam, to enhance the separation organic materials from the fluid.

In operation as a CO₂ stripper, fluid having CO₂ dissolved therein (i.e., CO₂-rich fluid) may be introduced through the inlet 23 and uniformly distributed on to the column of media 20, in a manner described above. As the CO₂-rich fluid descends through the column of media 20, atmospheric air or other fluids containing, for instance, very little or no CO₂, may be introduced tangentially through the external port 19, into the plenum 15, such that once it moves across the annulus 18, the air flows cyclonically into the spatial gap 21, and up through the column of media 20 in a countercurrent manner to the flow of fluid.

Alternatively, atmospheric air or other CO₂-deficient fluids may be introduced through pipe 28 downward into the column of media 20 in a co-current manner to the flow of fluid to be treated. It should be noted that although only one pipe 28 is illustrated, multiple pipes 28 may be provided. In addition, a plenum and annulus may be provided in connection with pipe 28 to facilitate the cyclonic flow of, for instance, the CO₂-deficient fluid into column 11.

It should be noted that the introduction of CO₂-deficient fluid through the external port 19 or pipe 28 may be enhanced by the presence of positive pressure, such as through the use of a blower (not shown).

As the CO₂-deficient fluid, in this case, air, comes into contact with the CO₂rich fluid, there can be an exchange (i.e., diffusion) of CO₂ molecules from the CO₂rich fluid to the CO₂-deficient air, resulting in the removal of CO₂ from the CO₂-rich fluid. The now substantially purified fluid may continue down the column of media 20, across the spatial gap 21 and exit through the outlet 26. As for the now substantially CO₂-rich air, it may escape, for example, through the pipe 28 in the countercurrent embodiment, and through port 19 in the co-current embodiment. Although CO₂ is provided as an example, the apparatus 10 may be used to strip other gases or gaseous compounds from the fluid to be treated.

It should be appreciated that the apparatus 10 may similary be used as an O₂ contactor to oxygenate oxygen-poor fluids. In particular, by introducing oxygen-enriched gas or other oxygen-enriched fluids into the apparatus 10, in either a countercurrent manner through external port 19 or a co-current manner through pipe 28, similar to that described above, as the oxygen-poor fluid moves through the packed column media 20, there may be an exchange of O₂ molecules from the oxygen-enriched gas to the oxygen-poor fluid, resulting in the addition of O₂ to the oxygen-poor fluid.

In another embodiment, the apparatus 10 may operate as an organic separator and a CO₂ stripper concurrently. For example, fluid rich in organic materials and CO₂ may initially be introduced through the inlet 23 and permitted to descend through the column of media 20 for treatment. As the treated fluid descends through the column of media 20 and bubbles are generated, the organic material dissolved in the treated fluid may be permitted to separate from the treated fluid and adhere/adsorb to the bubbles. While the organic materials are being separated from the fluid in apparatus 10, a CO₂deficient fluid, in this case, a gas, may be introduced through injection port 29 and permitted to ascend upward through the column of media 20 in a countercurrent manner to the flow of the treated fluid. Alternatively, a CO₂-deficient gas may be introduced through pipe 28 and permitted to descend downward through the column of media 20 in a co-current manner to the flow of the treated fluid. It should be noted while CO₂-deficient gas is introduced through injection port 29 or pipe 28, O₂, O₃ or ozone-enriched oxygen may also be introduced through injection port 29 to facilitate the break down on organics in the treated fluid and promote adherence of the organic materials to the bubbles. To this end injection port 29 may include multiple ports and may include a plenum as described above. As the CO₂-deficient gas interacts with the treated fluid rich in CO₂ within the column of media 20, diffusion of CO₂ molecules from the CO₂-rich treated fluid to the CO₂-deficient gas can occur.

The treated fluid, now substantially free of the dissolved organic materials and CO₂, may be collected at the second end 14 of the column 11. As for the bubbles, as they exit the column of media 20 with the organic materials adhering thereto, the bubbles may be permitted to coalesce into foam on the surface of the collected treated fluid and within the spatial gap 21. Thereafter, the coalesced foam in the spatial gap 21 may be directed through the annulus 18 and into the plenum 15. Once the foam is within the plenum 15, the foam may be removed through the external port 19. As for the now CO₂-rich gas, it may escape, for example, through pipe 28 in the countercurrent embodiment, or through external port 19 and/or injection port 29 in the co-current embodiment.

Apparatus 10 may further operate as a organic separator and an oxygenator concurrently. In this embodiment, fluid rich in organic materials and low in oxygen may be permitted to flow through the column of media 20 for treatment. However, unlike the process for stripping CO₂, an oxygen-rich gas, rather than CO₂-deficient gas, may be introduced through injection port 29 and allowed to flow upward in a countercurrent manner to oxygenate the fluid being treated. In another embodiment, oxygen-rich gas may be introduced through pipe 28 and allowed to move downward in a co-current manner with the fluid to be oxygenated. In either case, as the organic materials are removed from the treated fluid, the fluid may simultaneously be enriched with oxygen.

While the invention has been described in connection with the specific embodiments thereof, it will be understood that it is capable of further modification. For instance, apparatus 10 may be used to strip, from the fluid, any gas other CO₂, for instance, nitrogen, argon, sulfur, or enrich the fluid with any gas other than O₂, individually or concurrently with removal of organic materials from the fluid. Furthermore, this application is intended to cover any variations, uses, or adaptations of the invention, including such departures from the present disclosure as come within known or customary practice in the art to which the invention pertains, and as fall within the scope of the appended claims.

What is claimed is:

1. An apparatus for facilitating separation of material dissolved in a fluid to be treated, the apparatus comprising:
a column having an interior chamber extending between a first end and a second end of the column;
a plenum situated circumferentially about the second end of the column and having a lower end,
an annulus positioned at a junction between the plenum and the interior chamber so as to permit the plenum to be in fluid communication with the interior chamber of the column;
an external port in communication with the plenum;
a column of media positioned within the interior chamber, such that a spatial gap is defined between an end of the column of media closest to the annulus and the lower end of the plenum; and
an inlet positioned at the first end of the column and through which fluid to be treated may be introduced on to the column of media.

2. An apparatus as set forth in claim 1, wherein the column of media includes a plurality of high surface area material designed to enhance air to fluid interface.

3. An apparatus as set forth in claim 1, wherein the inlet is constructed so that fluid introduced therethrough may be uniformly distributed across the column of media.

4. An apparatus as set forth in claim 1, further including a perforated support plate positioned across the interior chamber and on which the column of media is placed.

5. An apparatus as set forth in claim 1, further including an outlet in communication with the spatial gap and through which treated fluid may exit from the apparatus.

6. An apparatus as set forth in claim 5, further including a controller on the outlet to regulate outflow of treated fluid from the column, such that an amount of treated fluid is permitted to remain within the column to define the height of the spatial gap between the end of the column of media adjacent to the annulus and the lower end of the plenum.

7. An apparatus as set forth in claim 1, further including an opening to permit exposure of the interior chamber to an atmospheric environment.

8. An apparatus as set forth in claim 1, further including an injection port to permit injection of a gaseous material into the packed column of media.

9. An apparatus as set forth in claim 1, further including a second spatial gap between the inlet and an end of the column of media adjacent to the first end of the column.

10. An apparatus as set forth in claim 9, further including a perforated plate above the second spatial gap, such that fluid introduced through the inlet may be spread uniformly across the perforated plate and to uniformly distributed across the gap on to the column of media.

11. A method for facilitating separation of material dissolved in a fluid to be treated, the method comprising:
(a) providing apparatus comprising:
a column having an interior chamber extending between a first end and a second end of the column;
a plenum situated circumferentially about the second end of the column and having a lower end,
an annulus positioned at a junction between the plenum and the interior chamber so as to permit the plenum to be in fluid communication with the interior chamber of the column;
an external port in communication with the plenum;
a column of media positioned within the interior chamber, such that a spatial gap is defined between an end of the column of media closest to the annulus and the lower end of the plenum; and
an inlet positioned at the first end of the column and through which fluid to be treated may be introduced on to the packed column of media
(b) introducing, through the inlet and on to the column of media, a fluid to be treated having material dissolved therein;
(c) generating bubbles as the fluid descends through the column of media;
(d) allowing the material dissolved in the fluid to separate from the fluid and adhere to the bubbles;
(e) collecting, at the second end of the column, the treated fluid substantially free of the material;
(f) permitting the bubbles having the adhered material to coalesce into foam on the surface of the collected treated fluid and within the spatial gap as the bubbles exit from the column of media;
(g) directing the coalesced foam in the spatial gap through the annulus and into the plenum; and
(h) removing the foam within the plenum through the external port.

12. A method as set forth in claim 11, wherein the step of introducing fluid includes uniformly distributing the fluid to be treated across the column of media.

13. A method as set forth in claim 12, wherein the step of introducing fluid further includes permitting the fluid to be treated to drip on to the column of media.

14. A method as set forth in claim 11, wherein the step of introducing fluid further includes introducing air into the column such that the air comes into contact with the fluid.

15. A method as set forth in claim 11, wherein the step of generating includes breaking up the fluid, so as to enhance an air to water interface ratio to increase bubble formation.

16. A method as set forth in claim 11, wherein the step of generating includes injecting one of oxygen, ozone, and oxygen-enriched ozone into the column of media to enhance formation of bubbles.

17. A method as set forth in claim 11, wherein in the step of collecting the treated fluid includes:
regulating the outflow of the treated fluid from the column, such that an amount of treated fluid is permitted to remain within the column to define the height of the spatial gap between the end of the column of media closest to the annulus and the lower end of the plenum; and
maintaining the spatial gap at a height sufficient to enhance coalescing of the bubbles into foam and to minimize destruction of the coalesced foam by treated fluid exiting the column of media.

18. A method for facilitating separation of material dissolved in a fluid to be treated, the method comprising:
providing a column of media;
distributing fluid to be treated on to the column of media;
generating bubbles as the fluid descends through the column of media;
allowing material dissolved in the fluid to separate from the fluid and adhere to the bubbles;
collecting the bubbles having the material adhered thereto as the bubbles exit from the column of media; and
removing the bubbles having the adhered material.

19. A method as set forth in claim 18, wherein the step of generating includes injecting one of oxygen, ozone, and oxygen-enriched ozone into the column of media to enhance formation of bubbles.

20. A method for facilitating gas exchange in a fluid to be treated, the method comprising:
(a) providing apparatus comprising:
a column having an interior chamber extending between a first end and a second end of the column;
a plenum situated circumferentially about the second end of the column and having a lower end,
an annulus positioned at junction between the plenum and the interior chamber so as to permit the plenum to be in fluid communication with the interior chamber of the column;
an external port in communication with the plenum;
a column of media positioned within the interior chamber, such that a spatial gap is defined between an end of the column of media closest to the annulus and the lower end of the plenum; and
an inlet positioned at the first end of the column and through which fluid to be treated may be introduced on to the packed column of media
(b) introducing, through the inlet and on to the column of media, a fluid to be treated having a first content of a gas to be exchanged;
(c) injecting, through the external port, a second fluid having a second content of the gas to be exchanged;
(d) permitting the second fluid to travel up through the column of media to contact the fluid to be treated;
(e) allowing a diffusion process to occur between the fluid to be treated and the second fluid, such that the gas content in each of the fluids is altered;
(f) collecting, at the second end of the column, the fluid having an altered first gas content; and
(g) removing from the column, the second fluid having an altered second gas content.

21. A method as set forth in claim 20, wherein the step of introducing fluid includes uniformly distributing the fluid to be treated across the column of media.

22. A method as set forth in claim 21, wherein the step of introducing the fluid to be treated further includes permitting the fluid to be treated to drip on to the packed column of media.

23. A method as set forth in claim 20, wherein the step of permitting includes allowing the second fluid to exit from the plenum through the annulus in a cyclonic flow pattern.

24. A method as set forth in claim 20, wherein the step of permitting includes allowing the second fluid to travel through the column of media in a countercurrent direction relative to the flow of fluid to be treated.

25. A method as set forth in claim 20, wherein the step of providing includes providing the apparatus with an intake pipe, so that the second fluid can be injected therethrough in a co-current direction relative to the flow of fluid to be treated.

26. A method as set forth in claim 20, wherein the step of introducing includes breaking up the first gas-rich fluid as it travels through the column of media so as to enhance an air to water interface ratio to increase gas diffusion.

27. A method for facilitating gas exchange in a fluid to be treated, the method comprising:
providing a column of media;
distributing, on to the column of media, a fluid to be treated having a first content of a gas to be exchanged;
injecting, into the column of media, a second fluid having a second content of a gas to be exchange, so as to permit contact with the fluid to be treated;
allowing a diffusion process to occur between the fluid to be treated and the second fluid, such that the gas content in each of the fluids is altered;
collecting, at the second end of the column, the fluid having an altered first gas content; and
removing from the column, the second fluid having an altered second gas content.

28. A method as set forth in claim 27, wherein the step of injecting includes allowing the second fluid to travel up through the column of media in a countercurrent direction relative to the flow of fluid to be treated.

29. A method as set forth in claim 27, wherein the step of injecting includes allowing the second fluid to travel down through the column of media in a co-current direction relative to the flow of fluid to be treated.

30. A method of treating a fluid to concurrently separate organic materials dissolved in the fluid and promote gas exchange from the fluid, the method comprising:
providing a column of media;
distributing, on to the column of media, a fluid to be treated having a first content of a gas to be exchanged;
generating bubbles as the fluid descends through the column of media;
allowing organic materials dissolved in the fluid to separated from the fluid and adhere to the bubbles;
injecting, into the column of media, a second fluid having a second content of the gas to be exchanged, so as to permit contact with the fluid to be treated;
permitting a diffusion process to occur between the fluid to be treated and the second fluid, such that the gas content in each of the fluids is altered;
collecting the bubbles having the adhered organic materials as the bubbles exit from the column of media; and
collecting the treated fluid having an altered first gas content.

31. A method as set forth in claim 30, further comprising removing the removing from the column of media the second fluid having an altered second gas content.

32. A method as set forth in claim 30, wherein the step of generating includes injecting one of oxygen, ozone, and oxygen-enriched ozone into the column of media to enhance formation of bubbles.

33. A method as set forth in claim 30, wherein the step of injecting includes allowing the second fluid to travel up through the column of media in a countercurrent direction relative to the flow of fluid to be treated.

34. A method as set forth in claim 30, wherein the step of injecting includes allowing the second fluid to travel down through the column of media in a co-current direction relative to the flow of fluid to be treated.
